(19) United States
(12) Patent Application Publication
(10) Pub. No.: US 2018/0332687 A1
(43) Pub. Date: Nov. 15, 2018

(54) ENERGY SCAVENGING DEVICE, AND SENSOR DEVICE, AND LIGHTING SYSTEM

(71) Applicant: PHILIPS LIGHTING HOLDING B.V., EINDHOVEN (NL)

(72) Inventors: JOHAN-PAUL MARIE GERARD LINNARTZ, EINDHOVEN (NL); RENÉ VAN HONSCHOOTEN, NUENEN (NL); MARCEL BEIJ, SINT OEDENRODE (NL); JOHANNES HUBERTUS GERARDUS OP HET VELD, ROERMOND (NL)

(21) Appl. No.: 15/542,455

(22) PCT Filed: Dec. 18, 2015
(86) PCT No.: PCT/EP2015/080564

§ 371 Date: Jul. 10, 2017

(30) Foreign Application Priority Data
Jan. 9, 2015 (EP) 15150639.1

(51) Int. Cl. H05B 37/02; H02J 7/00; H02M 3/156; H02M 3/158

(52) U.S. Cl. CPC H05B 37/0218; H02J 7/0063; H02J 7/345; H02M 3/158; H02M 3/156

(57) ABSTRACT

A power scavenger circuit (180) in a sensor device (100) for a lighting system (1) comprises: a controllable boost converter (110) having an input (111, 112) for receiving an input current (Iin) from an interface (2), and having an output (119a, 119b) for providing an output voltage (VB); a capacitor (130) coupled to the output of the boost converter (110); a second converter (140) having an input (141, 142) coupled to the capacitor and having an output (149a, 149b) for providing a supply voltage (VDD) for a microprocessor (150). A scavenging control device (120) has a sensing input (121) coupled to said converter input for sensing the voltage (Vout) at said converter input. The scavenging control device controls the boost converter in such manner that the sensed voltage is kept constant, so that the voltage at said interface can be considered as an output signal from the sensor device.

### FIELD OF THE INVENTION

The present invention relates in general to the field of energy scavenging, more particularly to an energy scavenging device for use in a sensor device for use in a lighting system.

### BACKGROUND OF THE INVENTION

Publication US 2009/0015216 A1 discloses a power scavenging circuit for scavenging power from a variable current, constant voltage source wherein the circuit regulates the voltage drop over the input terminal of the circuit. Such a circuit may be used in 4-20 mA current loops which are widely used in the process control industry.

Energy scavenging, or energy harvesting, is a phrase commonly used for techniques where energy is obtained from environmental sources, such as for instance daylight, electromagnetic fields, etc. Typically, the energy obtained is in the form of electrical energy. Harvesting energy from an environmental source allows electronic devices to operate without being wired to a supply and without the need to have batteries. The devices can thus be operated at a remote place for a prolonged time without receiving maintenance such as replacing batteries. The environmental source usually only provides relatively low power, but by accumulating and storing, for instance by charging a capacitor, it is possible to briefly power a load that consumes relatively high power.

The wording “scavenging” or “harvesting”, which wordings will be considered as equivalent for the purpose of the present invention, relate to the fact that, for the purpose of providing electric supply to an electronic device, use is made of a phenomenon that is present anyway while that phenomenon was neither designed nor provided for supplying such electronic device. In the context of the present invention, this view will be extended to a case where the phenomenon is an electrical signal not intended for power supply purposes.

In the field of lighting, especially smart lighting, the aim is not just to turn lighting on or off by a human controller. The aim is turn lighting on or off, or to set a dim level between 0 (off) and 100% (fully on), automatically on the basis of ambient factors such as for instance, but not exclusively, the level of daylight or the presence of a person. For this purpose, a control system for a lighting system, comprising one or more light sources, comprises a controller for the light source(s) and one or more sensors and/or detectors for sensing the daylight level or detecting a presence, et cetera. A problem exists in powering the components of the control system.

Providing power for the controller as such is not such a big challenge in this context. A controller is either integrated with a light source or is remote from the controlled light source. In the case of a controller integrated with a light source, there is power available for the controller since the light source will receive power derived from mains. In the case of a remote controller, it will be possible to arrange the controller at a position of the respective power source for that lighting unit, and to combine or integrate the wires from power source to lighting unit and the wires from controller to lighting unit.

On the other hand, the sensors may typically (need to) be arranged at a position where no power supply (mains) is available. Nevertheless, even if mains power is available, individually powering a sensor from mains is relatively expensive. Likewise, providing a separate power supply for the sensor(s), which needs to be wired to the sensor(s), is relatively expensive. If that power supply would be a battery, it would pose the burden of needing regular replacement.

The challenge underlying the present invention is to provide a low-cost power provision for the sensors of an intelligent lighting system. It is to be noted that the solution offered by the present invention is not exclusively useful for powering sensors but can also be applied in other situations.

In intelligent lighting systems, which comprises light sources and a control system, a wired interface is used for coupling to the sensors. The sensors provide an electrical measuring signal over the interface, to be used by a controller for controlling lamps, but the sensors do not have a power source for the reasons mentioned above. Therefore, at a central location that receives the sensor signals, an electrical interrogation signal is sent over the interface wires to the sensor, and the sensor's response signal is processed as measuring signal.

In a specific embodiment the electrical interrogation signal is a constant current signal. The sensor has a feature of adapting its impedance depending on the parameter to be measured, so that the response signal or measuring signal is the voltage developing over the interface terminals. A standard and widely used interface is a 1 . . . 10 Volt interface. Such interface includes a driver that produces a constant current of 150 μA; depending on the measured parameter, the sensor/detector adapts its impedance so that at the driver side a voltage drop is measured in the range of 1 to 10 Volt, representing the measurement signal.

### SUMMARY OF THE INVENTION

It would be advantageous to have sensors with built-in intelligence, which means that the sensor will have a built-in micro-controller or similar control device. Technically, it would be possible to power such micro-controller from a battery but, as indicated earlier, apart from the inconvenience of the need to change batteries this is a rather expensive solution. It would therefore be advantageous if the micro-controller could be powered from the interface. However, a standard micro-controller will require a supply voltage of at least 3.3 V, so it is not possible to simply power the micro-controller directly from the interface.

According to one aspect of the present invention, such remote interface-coupled sensor is provided with an energy scavenging device.

In prior art, energy scavengers typically have a general design of (1) a converter, for converting the ambient phenomenon to an electrical signal, (2) a charger for charging (3) a capacitor, and (4) a control for controlling the charger such as to keep the capacitor charged. In the present context, the “ambient phenomenon” would be the interrogation signal on the interface lines. However, applying the prior art design is not possible, since the interrogation signal is a constant current signal and the charging of the capacitor would inevitably affect the interface line voltage which represents the sensor measuring signal and should remain undisturbed.

The present invention aims to provide a solution to the above problems.

Particularly, the present invention aims to provide an energy scavenging circuit that is capable of harvesting electrical energy from a line carrying constant current without affecting line voltage.

According to an important aspect of the present invention, an energy scavenging circuit comprises an energy storage device, a boost converter for receiving input current and charging the energy storage device, and a buck converter supplied from the energy storage device, as well as a control device for controlling the boost converter on the basis of the input voltage.

Further advantageous elaborations are mentioned in the dependent claims.

### BRIEF DESCRIPTION OF THE DRAWINGS

These and other aspects, features and advantages of the present invention will be further explained by the following description of one or more preferred embodiments with reference to the drawings, in which same reference numerals indicate same or similar parts, and in which:

FIG. 1 is a schematic block diagram of an exemplary embodiment of a smart sensor device according to the present invention;

FIG. 2 is a schematic block diagram of an exemplary embodiment of a scavenger circuit according to the present invention;

FIG. 3 is a schematic block diagram of an exemplary embodiment of a supply circuit according to the present invention.

### DETAILED DESCRIPTION OF THE INVENTION

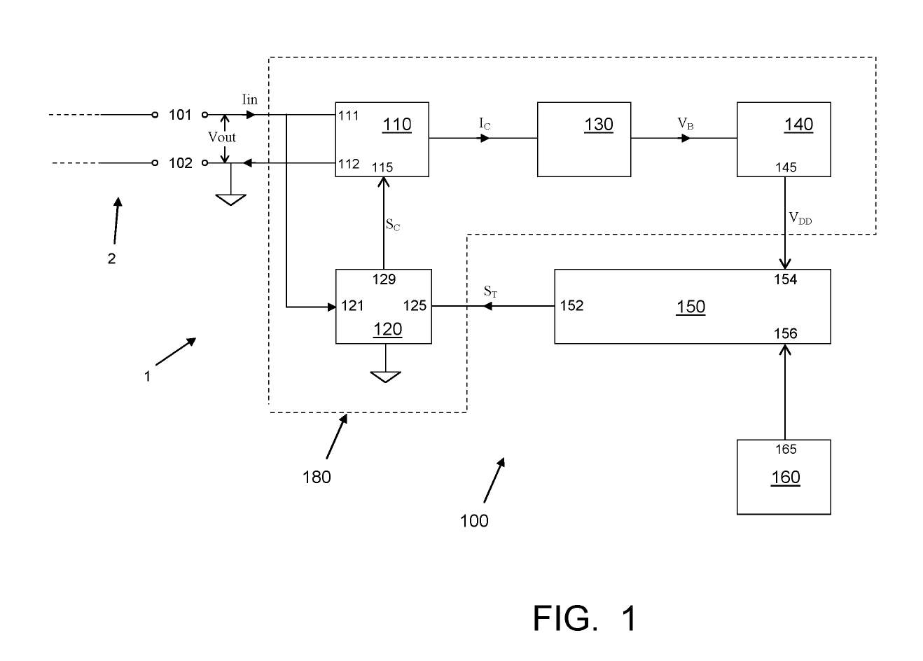

FIG. 1 is a schematic block diagram showing an exemplary smart sensor device 100 proposed by the present invention. The smart sensor device 100 is part of a lighting system 1, which further comprises an interface 2 to which the sensor device 100 is connected. The lighting system 1 will also include lighting units, but these are not shown for sake of simplicity.

The smart sensor device 100 comprises a scavenger circuit 180, a main control device 150, and a sensing element 160, for sensing a parameter, for instance ambient light level. The main control device 150 may for instance comprise a micro-controller. The smart sensor device 100 further has interface terminals 101, 102 for connecting to interface lines of a standard 1 . . . 10 Volt interface 2. Such interface comprises a driver, which is not part of the smart sensor device 100 and therefore not shown for sake of simplicity, which provides on the interface lines a constant current Iin, which can be considered as an input current for the smart sensor device 100. For cooperating with the driver in accordance with the interface standard, the smart sensor device 100 is expected to show an effective impedance such that the voltage over the interface lines has a certain value which can be considered as an output voltage Vout from the smart sensor device 100, and which corresponds to a value measured by the sensing element 160.

In conventional circuits, a low-drop voltage regulator would be used for supplying the micro-controller, together with a bleeder to ensure that the interface can deliver the constant current of 150 μA into the control device. According to the present invention, however, the scavenger circuit 180 comprises a controllable boost converter 110, an energy storage device 130, a second converter 140, and a scavenging control device 120. Preferably, the second converter 140 is a buck converter.

The controllable boost converter 110 has input terminals 111, 112 coupled to the interface terminals 101, 102. An output of the boost converter 110 is coupled to an input of the energy storage device 130, which typically can comprise a capacitor. Energy transfer from the boost converter 110 to the energy storage device 130 is done in the form of a charging current Ic. The charge in the energy storage device 130 will result in a boosted voltage VB of the energy storage device 130.

An output of the energy storage device 130 is coupled to an input of the second converter 140, which has a supply output 145 for providing a supply voltage VDD. The main control device 150 has a supply input 154 receiving the supply voltage VDD.

The controllable boost converter 110 is controlled by a control signal SC from the scavenging control device 120. To this end, a control output 129 of the scavenging control device 120 is coupled to a control input 115 of the controllable boost converter 110. The scavenging control device 120 has a sensing input 121 coupled to the interface terminal 101 for sensing the interface voltage. The scavenging control device 120 is adapted to control the boost converter 110 in such manner that the voltage sensed at its sensing input 121 is kept constant.

The sensing element 160 of the smart sensor device 100 has an output 165 coupled to a measuring input 156 of the main control device 150. Based on the measuring signal received at its measuring input 156, the main control device 150 generates a target signal ST at a control output 152, which is coupled to a target input 125 of the scavenging control device 120. The scavenging control device 120 is adapted to control the boost converter 110 in such manner that the voltage sensed at its sensing input 121 is kept equal to the target signal ST received at its target input 125.

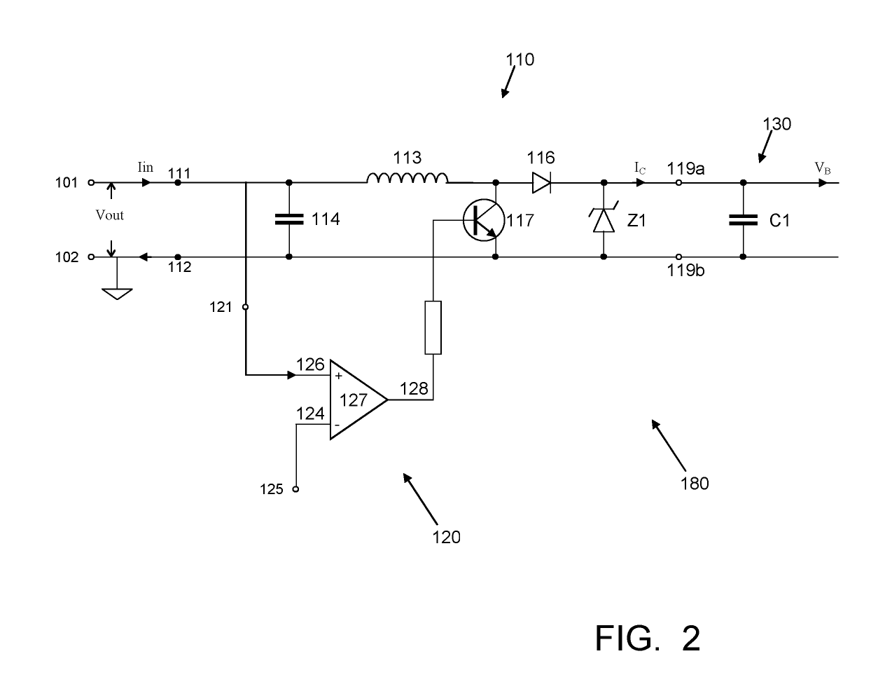

FIG. 2 is a schematic block diagram of a portion of an exemplary embodiment of a scavenger circuit 180 according to the present invention. The boost converter 110 has its input terminals 111, 112 connected to the interface terminals 101, 102, and has output terminals 119a, 119b. A buffer capacitor 114 is connected in parallel to said input terminals 111, 112. The energy storage device 130 comprises a relatively large capacitor C1, for instance of 1 μF, coupled in parallel to said output terminals 119a, 119b. A Zener diode Z1 is connected in parallel to the energy storage capacitor C1, and functions to limit the voltage VB over the energy storage capacitor C1. The Zener diode Z1 may be part of the boost converter 110 or may be part of the energy storage device 130. The main function of the Zener diode Z1 is to prevent damage to the energy storage capacitor C1 due to overcharging, hence the Zener voltage, which in an embodiment may be for instance 30 V, is selected in conformity with the rating of the energy storage capacitor C1. Another function of the Zener diode Z1 is to protect a next stage, i.e. the boost converter 140 which will be discussed later, against excessively large input voltages.

The boost converter 110 comprises a series connection of an inductor 113 and a diode 116 connected between one input terminal 111 and one output terminal 119a, and comprises a controllable switch 117, in the embodiment shown implemented as a transistor, connecting the node between inductor 113 and diode 116 to a common line connecting the second input terminal 112 to the second output terminal 119b.

The scavenging control device 120 is shown as comprising a comparator 127, having an output terminal 128 coupled to a control terminal of the controllable switch 117, having a non-inverting input terminal 126 coupled to the sensing input 121, and having an inverting input terminal 124 coupled to the target input 125. The comparator 127 may be implemented as part of the boost converter 110, in which case the target input 125 is an input terminal of the boost converter 110 connected to a control output terminal 152 of the main control device 150. The comparator 127 may alternatively be implemented as part of the main control device 150, in which case the non-inverting input terminal 126 is an input terminal of the main control device 150 and the output terminal 128 is an output terminal of the main control device 150 connected to an input terminal of the boost converter 110. It is noted that a signal shaper may be included in the connection between 152 and 125, for instance a filter.

As will be clear to a person skilled in the art, the controllable switch 117 is alternated between a conductive state and a non-conductive state, causing the inductor 113 to generate current pulses that charge the energy storage capacitor C1 to a boost voltage VB. The energy storage capacitor C1 functions as intermediate power supply for a next stage, in this case a supply stage for the supply circuit 140, as will be described later. In conventional boost converter circuits, the voltage at the output terminals 119a, 119b would be sensed and the control for the controllable switch 117 would be such as to keep the output voltage at a desired constant level. According to the inventive concept underlying the present invention, switching of the controllable switch 117 is controlled such as to keep the input voltage at the input terminals 111, 112, and hence the interface voltage Vout, at a desired constant level, which is the target voltage ST set by the main control device 150 at the control terminal 125. If the actual value of the interface voltage Vout is higher than the target voltage VT, the comparator 127 controls the controllable switch 117 to a conductive state: the interface current IC charges the inductor 113 and the interface voltage decreases. If the actual value of the interface voltage Vout is lower than the target voltage VT, the comparator 127 controls the controllable switch 117 to a non-conductive state: the interface current IC charges the buffer capacitor 114 and the interface voltage increases, and the inductor 113 discharges into the energy storage capacitor C1. The Zener diode Z1 defines an upper limit of the voltage of the energy storage capacitor C1, i.e. the Zener diode Z1 defines when the energy storage capacitor C1 is full: once the voltage of the energy storage capacitor C1 has reached the Zener voltage, the Zener diode becomes conductive and the interface current IC will be drained through the Zener diode. Thus, effectively, all energy from the interrogation signal on the interface lines is either used in boost converter 140 or stored in capacitor 130. Only when the storage capacitor 130 is already fully charged, any excess energy is dissipated by Zener diode Z1.

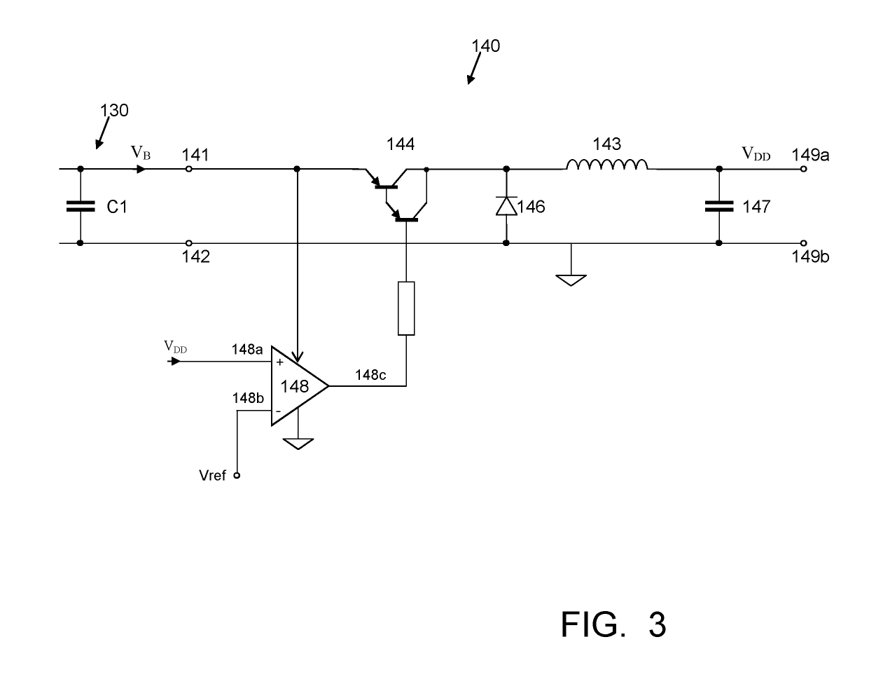

FIG. 3 is a schematic block diagram of an exemplary embodiment of a second converter 140 according to the present invention, also indicated as supply circuit. The supply circuit 140 has input terminals 141, 142 connected to the energy storage capacitor C1, and has output terminals 149a, 149b. An output capacitor 147 is connected in parallel to said output terminals 149a, 149b. The supply circuit 140 is implemented as a buck converter, comprising a series connection of a controllable switch 144 and an inductor 143 connected between one input terminal 141 and one output terminal 149a, and comprising a diode 146 connecting the node between switch 144 and inductor 143 to a common line connecting the second input terminal 142 to the second output terminal 149b. In the embodiment shown, the switch 144 is implemented as a Darlington configuration.

A control device for the controllable switch 144 is implemented as a comparator 148, having an output terminal 148c coupled to a control terminal of the controllable switch 144, having a non-inverting input terminal 148a coupled to the first output terminal 149a, and having an inverting input terminal 148b coupled to a reference voltage source Vref, which corresponds to a suitable operating voltage for the main control device 150. The inverting input terminal 148b may be coupled to an output of the main control device 150 to receive the reference voltage Vref.

As will be clear to a person skilled in the art, the controllable switch 147 is alternated between a conductive state and a non-conductive state, causing the inductor 143 to generate current that charges the output capacitor 147 to an output supply voltage VDD. If the actual value of the output supply voltage VDD is lower than the reference voltage Vref, the comparator 148 controls the controllable switch 144 to a conductive state: the inductor 143 is charged from the energy storage capacitor C1, and current flows from the energy storage capacitor C1 to the load 150 and the output capacitor 147. If the actual value of the output supply voltage VDD is higher than the reference voltage Vref, the comparator 148 controls the controllable switch 144 to a non-conductive state: the inductor 143 discharges into the load 150 and the output capacitor 147.

Operation is as follows. The control device 150 will receive supply voltage that is stabilized at a value VDD independent from the interface voltage Vout, and can draw a supply current that is independent from the interface current Iin. During time periods when the control device 150 (i.e. the micro-processor) has low activity and requires little energy, the constant current received from the interface at inputs 111, 112 is used to charge the energy storage capacitor C1 to a voltage level determined by the Zener diode Z1. The amount of energy that can thus be stored in the energy storage capacitor C1 will evidently depend on its capacitance. During time periods when the control device 150 requires more energy, this energy (voltage and current) will be supplied from the energy storage capacitor C1 and will not load the interface line.

Summarizing, the present invention provides a power scavenger circuit 180 in a sensor device 100 for a lighting system 1. The power scavenger circuit comprises:

a controllable boost converter 110 having an input 111, 112 for receiving an input current Iin from an interface 2, and having an output 119a, 119b for providing an output voltage VB;

a capacitor 130 coupled to the output of the boost converter 110;

a second converter 140 having an input 141, 142 coupled to the capacitor and having an output 149a, 149b for providing a supply voltage VDD for a microprocessor 150.

A scavenging control device 120 has a sensing input 121 coupled to said converter input for sensing the voltage Vout at said converter input.

The scavenging control device controls the boost converter in such manner that the sensed voltage is kept constant, so that the voltage at said interface can be considered as an output signal from the sensor device.

While the invention has been illustrated and described in detail in the drawings and foregoing description, it should be clear to a person skilled in the art that such illustration and description are to be considered illustrative or exemplary and not restrictive. The invention is not limited to the disclosed embodiments; rather, several variations and modifications are possible within the protective scope of the invention as defined in the appending claims.

For instance, instead of separate main and scavenging control devices, it is possible that both functions are implemented by one integrated control device.

Further, the invention has been explained for the case of a sensor for sensing the value of an ambient parameter, so that the output measuring value of the sensor device, i.e. the voltage at the interface, will in principle be continuously variable within a certain range. If the sensor would be functioning as a detector, which basically provides a limited set of discrete measurement results, for instance yes/no, the output measuring value of the sensor device, i.e. the voltage at the interface, will also have one of a limited range of discrete possibilities, for instance high/low.

Further, with the controlled interface voltage being an output signal from the device 100, the contents or meaning of this signal depends on the nature of the element 160. As such, this element is an element providing information to be signaled. In the above, this element has been explained as a sensor for sensing an ambient parameter; this ambient parameter may for instance be temperature or light intensity. In variations, the element 160 may also be, for instance, a clock unit.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. Even if certain features are recited in different dependent claims, the present invention also relates to an embodiment comprising these features in common. Any reference signs in the claims should not be construed as limiting the scope.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Smart sensor device comprising a power scavenger circuit for cooperating with a constant current, variable voltage interface, adapted to set the interface voltage based on a measuring signal, the power scavenger circuit comprising:
a controllable boost converter having an input for receiving an input current, and having an output for providing an output voltage;
an energy storage device coupled to the output of the boost converter;
a second converter having an input coupled to the energy storage device and having an output for providing a supply voltage;
a scavenging control device having a sensing input coupled to said input for sensing the voltage at said input, the scavenging control device further comprising a target input; the smart sensor device further comprising:
a sensing element for sensing an ambient parameter and having an output for providing a measuring signal representing a sensed value of said ambient parameter; and
a main control device having a supply input coupled to the output of the second converter, and having a measuring input coupled to said output of the sensing element, and having a control output coupled to the target input of the scavenging control device;
wherein the main control device is adapted to determine a target voltage signal representing the said measuring signal, and to provide said target voltage signal as output control signal at its control outputs,
wherein the scavenging control device adapted to control the boost converter in such manner that the voltage sensed at its sensing input is kept equal to the target signal received at its target input.

2. Smart sensor device according to claim 1, wherein the second converter is a buck converter.

3. (canceled)

4. (canceled)

5. Smart sensor device according to claim 1, wherein said information providing element comprises a remote control signal receiver for providing a measuring signal based on a received control signal from a remote control.

6. (canceled)

7. Smart sensor device according to claim 1, wherein the control device and the scavenging control device are integrated together.

8. Lighting system comprising a 1 . . . 10 Volt interface, and further comprising at least one smart sensor device according to claim 1 coupled to said interface.
